(19) United States
(12) Patent Application Publication
(10) Pub. No.: US 2013/0250283 A1
(43) Pub. Date: Sep. 26, 2013

(54) OPTICAL ASSEMBLY

(71) Applicant: Tae Ho Ha, Gyeonggi-do (KR)

(72) Inventor: Tae Ho Ha, Gyeonggi-do (KR)

(73) Assignee: LUTRONIC CORPORATION, Gyeonggi-do (KR)

(21) Appl. No.: 13/990,276

(22) PCT Filed: Nov. 29, 2011
(86) PCT No.: PCT/KR2011/009177

§ 371 Date: May 29, 2013

(30) Foreign Application Priority Data
Nov. 29, 2010 (KR) 10-2010-0119819
Nov. 29, 2010 (KR) 10-2010-0119820
Nov. 29, 2010 (KR) 10-2010-0119821

(51) Int. Cl. G01B 11/26

(52) U.S. Cl. CPC G01B 11/26
USPC 356/138

(57) ABSTRACT

The present invention relates to an optical assembly capable of sensing the rotational position of an optical member. The optical assembly comprises: an optical member; a support unit arranged to support the optical member such that the optical member rotates in a first axis direction, a second axis direction or a combined direction of the first axis and the second axis; a power providing unit which provides power for rotating the optical member; and a position sensing unit including a plurality of optical sensors to sense the rotational position of the optical member.

### TECHNICAL FIELD

The present invention concerns an optical assembly that may sense a rotational position of an optical member, and more specifically, to an optical assembly having a position sensing unit using an optical sensor, which may sense a light-receiving characteristic according to the rotational position of the optical member to precisely control the rotational position of the optical member.

### BACKGROUND ART

Optical apparatuses using light such as laser beams have wide industrial applications including medical industry.

Such an optical apparatus generally includes a light source for generating light and multiple optical members that are arranged on a path along which light emitted from the light source travels. At this time, each optical member is rotated and shifted in position, thereby modulating the characteristics of the light and changing the path of the light.

Among the optical members, some are controlled to be selectively rotated in the optical apparatus. As an example, a scanner is installed to reflect light that travels along a light path, and the light path is changed as the rotational position such as the direction and angle of rotation varies.

Such a conventional optical member is provided to be rotatable in the optical apparatus and requires a separate source to supply power, and this puts a restriction it being implemented in a small module.

Further, the rotational position and rotation speed of the optical member is difficult to control, thus making it difficult to provide the optical apparatus with higher accuracy.

### DETAILED DESCRIPTION OF INVENTION

### Technical Problems

To address the above problems, the present invention aims to provide an optical assembly that may control optical members more precisely and may be made compact with a source to supply power to the optical members.

### Technical Solutions

To achieve the above objects, the present invention provides an optical assembly comprising an optical member, a supporter provided so that the optical member is rotated in a direction of a first axis, a second axis, or a combination of the first axis and the second axis, a power providing unit supplying power to rotate the optical member, and a position sensing unit including a plurality of light sensors, wherein the position sensing unit senses a rotational position of the optical member. And, the optical assembly may further comprise a controller controlling a driving of the power providing unit in accordance with the rotational position of the optical member that is sensed by the position sensing unit.

At this time, the optical assembly may further comprise at least one light source positioned at a lower side of the optical member and emitting light, wherein the position sensing unit senses the rotational position of the optical member based on the amount or position of light emitted from the light source. Here, a separate light shielding unit may be formed between the light source and the position sensing unit, wherein the light shielding unit selectively shields the position sensing unit in accordance with the rotational position of the optical member.

Specifically, the light source may be provided to emit light from a lower side of the optical member to an outer side of the optical member, the plurality of light sensors may be arranged corresponding to a direction in which light is emitted from the light source along an outer direction of the optical member, and the light shielding unit may be extended from a lower surface of the optical member to a lower side and rotates with the optical member to selectively shield the position sensing unit.

The supporter may include a first holder formed along a circumference of the optical member so that the optical member is rotatably provided in the first-axis direction and a second holder formed along a circumference of the first holder so that the optical member and the first holder are rotatably provided in the second-axis direction.

Or, the supporter may include a first holder hinge-coupled to a lower side of the optical member so that the optical member is rotatable in the first-axis direction and a second holder hinge-coupled to an end of the first holder so that the optical member and the first holder are rotatable in the second-axis direction.

The optical member may include a mirror and a mirror plate where the mirror is installed, and the mirror plate may include a magnetic body having a magnetic pole. And, the power providing unit may include a plurality of magnetic force units that generate a magnetic force and may provide power to rotate the optical member using the magnetic force.

Specifically, two magnetic force units that provide power to rotate the optical member along the first axis may be arranged on a line of the second axis with respect to the first axis, and two magnetic force units that provide power to rotate the optical member along the second axis may be arranged on a line of the first axis with respect to the second axis.

### Advantageous Effects

According to the present invention, the optical members may be precisely controlled using the rotational position information of the optical members, and a compact structure may be provided that includes a position sensing unit and a power providing unit. Accordingly, the optical apparatus may be made small.

### BRIEF DESCRIPTION OF DRAWINGS

FIG. 1 is a perspective view illustrating an optical assembly according to a first embodiment of the present invention.

FIG. 2 is an exploded perspective view of the optical assembly shown in FIG. 1.

FIG. 3 is a cross-sectional view of the position sensing unit shown in FIG. 1.

FIG. 4 is a plan view of the position sensing unit shown in FIG. 3.

FIG. 5 is a view schematically illustrating an arrangement of the light sensors shown in FIG. 3.

FIG. 6 is a perspective view illustrating an optical assembly according to a second embodiment of the present invention.

FIG. 7 is a plan view of the optical assembly shown in FIG. 6.

FIG. 8 is a perspective view illustrating another example of the supporter shown in FIG. 6.

FIG. 9 is an exploded perspective view of the supporter shown in FIG. 8.

FIG. 10 is a perspective view illustrating still another example of the supporter sown in FIG. 6.

FIG. 11 is an exploded perspective view of the supporter shown in FIG. 10.

FIG. 12 is a cross-sectional view of the optical assembly shown in FIG. 12.

FIG. 13 is a cross-sectional view illustrating the polarity of the magnetic body of the optical member shown in FIG. 6.

FIGS. 14 and 15 are cross-sectional views illustrating the optical member that is rotated by the power providing unit shown in FIG. 6.

### BEST MODE

An optical apparatus according to the present invention will be described in detail with reference to the drawings. The relationship in position between the components is described based on the drawings. For ease of description, the structures in the drawings may be simplified or exaggerated. However, the present invention is not limited as having the configurations described hereafter, and more components may be added, or some of the components may be modified or omitted.

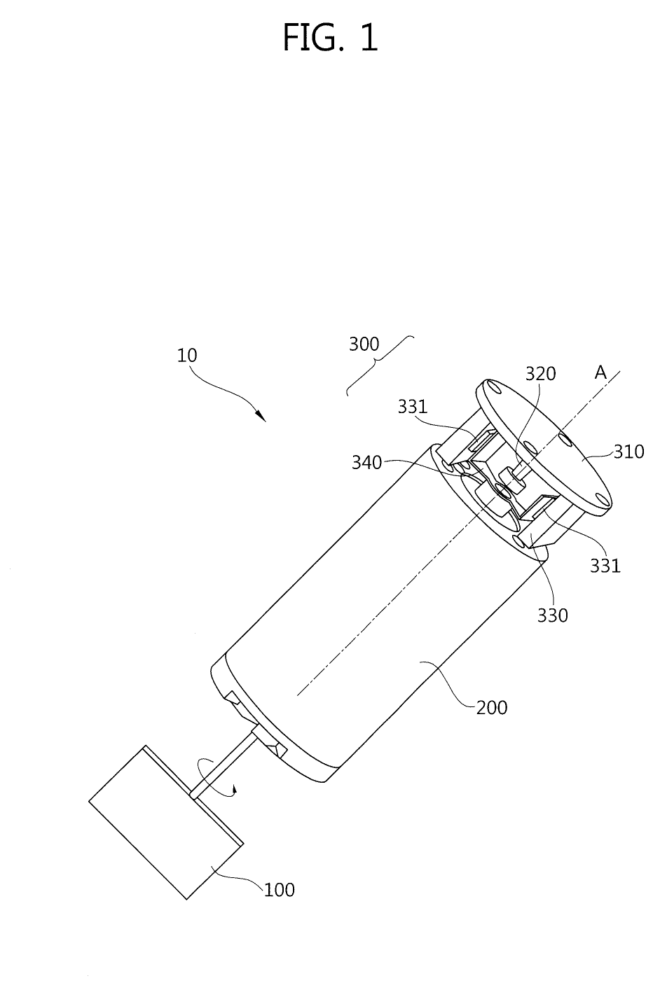

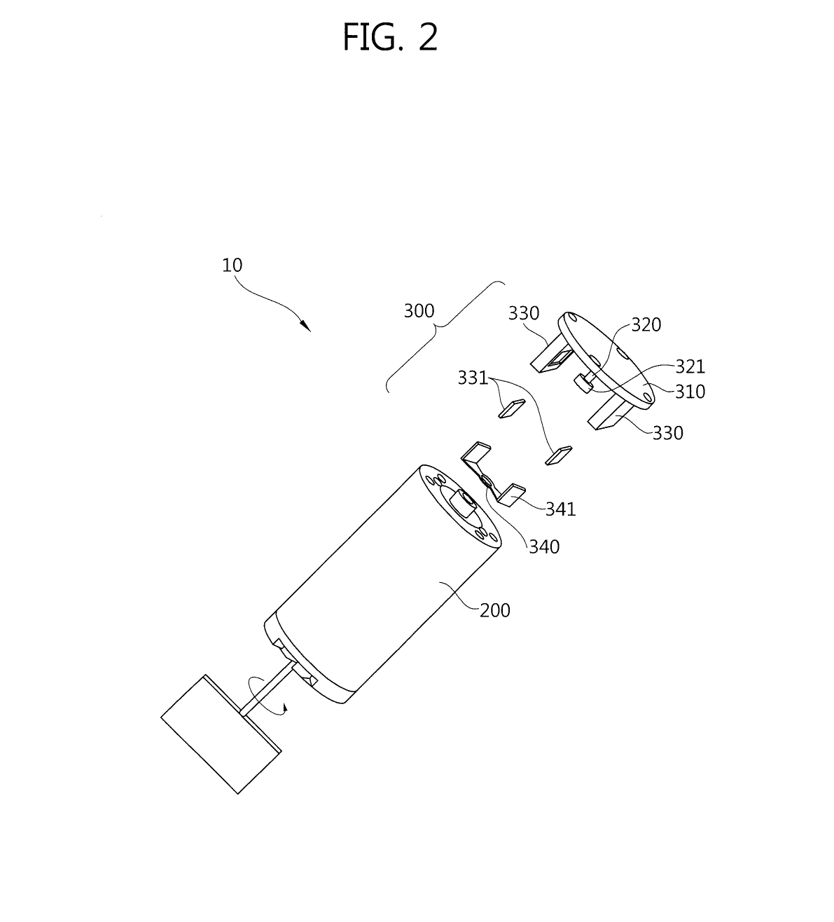

FIG. 1 is a perspective view illustrating an optical apparatus according to a first embodiment of the present invention, and FIG. 2 is an exploded perspective view of the optical apparatus shown in FIG. 1.

Referring to FIGS. 1 and 2, the optical assembly 10 according to this embodiment includes a power providing unit 200, an optical member 100 provided at a side of the power providing unit 200, and various components that are provided at the other side of the power providing unit 200 and sense the position of the optical member 100.

The optical member 100 may be constituted of, e.g., a mirror. The optical member 100 is rotatably installed. Accordingly, the optical member 100 may control the rotational position while arranged on a path along which light travels to change the light path. In this embodiment, for example, the optical member 100 is a mirror. However, various optical elements may be used to constitute the optical member 100.

The power providing unit 200 is provided at a side of the optical member 100 to supply power to rotate the optical member 100 to the optical member 100. The power providing unit 200 may be, e.g., a forward/reverse rotation motor. The optical member 100 may be installed at a side of the power providing unit 200 and may be rotated along the rotational axis A of the power providing unit 200 as the power providing unit 200 is driven. In this embodiment, the power providing unit 200 may be a forward/reverse rotation motor that may rotate 30 degrees angle in the forward direction and reverse direction each. However, besides the forward/reverse rotation motor, various driving sources may be adopted to constitute the power providing unit 200.

At the other side of the power providing unit 200 is formed a stage 310 that is arranged to be spaced apart from the power providing unit 200 by a predetermined distance. The stage 310 includes at least one light source 321 and a light sensor 331. At this time, the light source 321 and the light sensor 331 may be arranged to face each other so that light emitted from the 321 may be received by the light sensor 331.

Specifically, a plurality of light sensor supporters 330 are provided along the circumferential direction at the outer edge of the stage 310. The light sensor supporter 330 may extend in a direction parallel with the rotational axis of the power providing unit 200 and may fix the stage 310 to a side of the power providing unit 200. The light sensor 331 may be provided at an inside of the light sensor supporter 330 to be oriented towards the center of the stage 310.

Meanwhile, as shown in FIGS. 1 and 2, a light source supporter 320 is provided at a central portion of the stage 310. The light source supporter 320 is formed in a direction parallel with the rotational axis of the optical member 100 and may be positioned on an extension line of the rotational axis. At least one light source 321 is installed at the light source supporter 320 and emits light towards the light sensor 331 that is positioned at an outside portion. The light source 321 may include an IR LED (infra-red LED) or may include various types of light sources.

A light shielding unit 340 is positioned between the light source 321 and the light sensor 331 to selectively shield the light sensor 331. Here, although the light shielding unit 340 is herein described as selectively shielding the light sensor 331, from other points of view, it may be construed as selectively shielding the light source or as selectively shielding light emitted from the light source.

The light shielding unit 340 is connected to a rotating unit 350 of the power providing unit 200. The rotating unit 350 is provided in the power providing unit 200 and is supported by a bearing unit 360. The rotating unit 350 has the same rotational axis as the optical member 100. As the optical member 100 is rotated by the power providing unit 200, the rotating unit 350 also rotates in the direction in which the optical member 100 is rotated. Accordingly, the light shielding unit 340 may also be rotated with the optical member 100 while connected with the rotating unit 350.

The light shielding unit 340, as shown in FIGS. 1 and 2, is extended from the rotating unit 350 in an outside direction and is bent towards the light source supporter 320. In other words, the light shielding unit 340 forms a blade structure 341. Accordingly, as the light shielding unit 340 is rotated between the light source 321 and the light sensor 331, the light shielding unit 340 selectively shields the light sensor 331 in accordance with the rotational position. In such case, the amount and position of light that is emitted from the light source 321 and received by the light sensor 331 are varied. Therefore, the rotational position of the optical member 100 may be sensed based on the variation in the amount and position of light received by the light sensor.

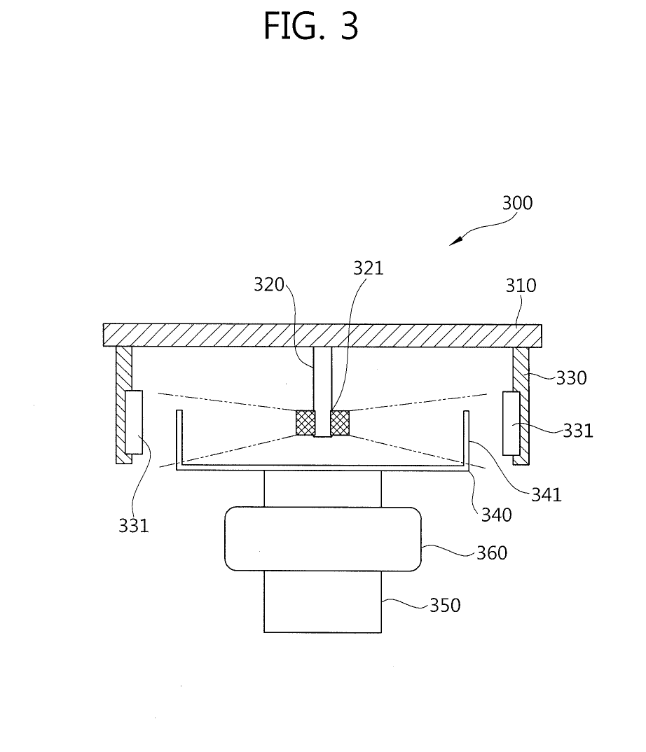

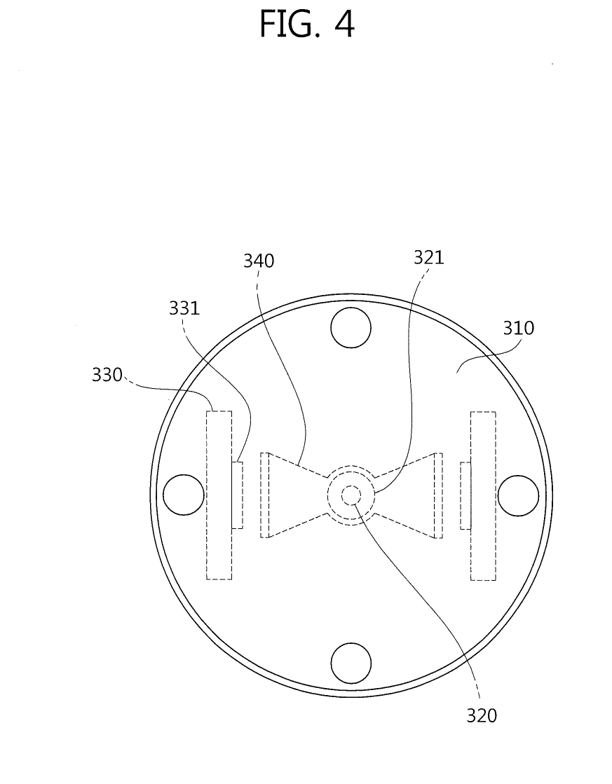

FIG. 3 is a cross-sectional view of the position sensing unit shown in FIG. 1, and FIG. 4 is a plan view illustrating the position sensing unit shown in FIG. 3.

As shown in FIGS. 3 and 4, the position sensing unit 300 includes at least one light source 321, at least one light sensor 331 for receiving light emitted from the light source 321, and a light shielding unit 340 for selectively shielding the light sensor 331 between the light sensor 331 and the light source 321.

As described above, the light shielding unit 340 is rotatably installed to correspond to the rotational position of the optical member 100, and depending on the rotational position of the light shielding unit 340, the amount and position of light received by the light sensor 331 are varied. Accordingly, the position sensing unit 300 may sense the rotational position of the optical member 100 based on the amount and position of light sensed by the light sensor.

At this time, the position sensing unit 300 may be preferably configured so that while the optical member 100 is on the move within a rotational trajectory, a part of light emitted from the light source 321 is shielded by the light shielding unit 340 and another part thereof is received by the light sensor 331. If in a specific section the light sensor is fully shielded or not shielded by the light shielding unit, even when the optical member travels in the corresponding section, there would be no change in the amount or position of light received by the light sensor, thus making it difficult to catch the precise rotational position of the optical member.

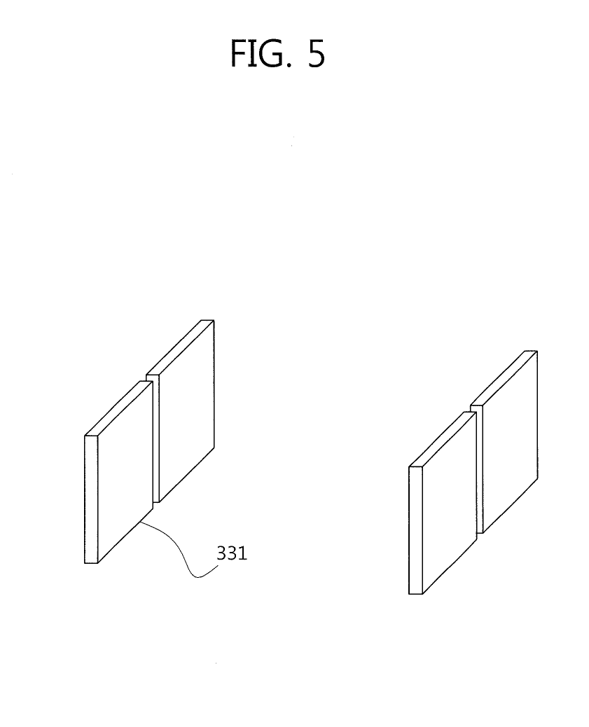

Accordingly, in the instant embodiment, as shown in FIG. 4, the length in the circumferential direction of the light sensor 331 is rendered longer than the length in the circumferential direction of the light shielding unit 340, so that part of light may be continuously received by the light sensor 331 in the rotational trajectory of the optical member 100. For this purpose, two or more light sensors 331 may be sequentially arranged as illustrated in FIG. 5.

Meanwhile, in this embodiment, the light source 321 and the light sensor 331 are spaced apart from each other at an interval of 180 degrees in the circumferential direction. The light shielding unit 340 has two blades that may be arranged at an interval of 180 degrees in the circumferential direction.

However, this is merely an example, and the light source and the light sensor may also be arranged at an interval of 60 degrees or 90 degrees along the circumferential direction. In such case, as the rotational position of the optical member varies, multiple light sensors may be advantageously combined to obtain the amount and position of light that is continuously changed. Further, in case multiple light sensors are used, even when some light sensors positioned at certain positions are broken, the remaining light sensors may be combined to sense the rotational position of the optical member.

As such, the optical assembly 10 according to an embodiment of the present invention may precisely determine, in real time, the rotational position of the optical member 100 using the position sensing unit 300 including the light sensor 331. Accordingly, a controller (not shown) that controls the driving of the power providing unit may perform real-time sensing on the rotational position of the optical member that is sensed by the position sensing unit 300 to control the driving, thus enabling precise position control on the optical member 100.

However, although in this embodiment the position sensing unit has been configured using the stage feature that is installed at an end of the power providing unit, this is merely an example, and various configurations may be made so that the position may be sensed using the light-receiving information of the light sensor depending on the rotational position.

For example, although in the present embodiment the light source is provided at an inside and irradiates light to the light source that is provided along the circumference, the light source, in contrast, may be installed along the circumferential direction to radiate light to the light sensor that is provided inside.

Further, the blade of the light shielding unit may have a through-hole or groove with a predetermined pattern, so that the light sensor may sense the position of the through-hole or groove, which is changed, thereby sensing the rotational position of the optical member.

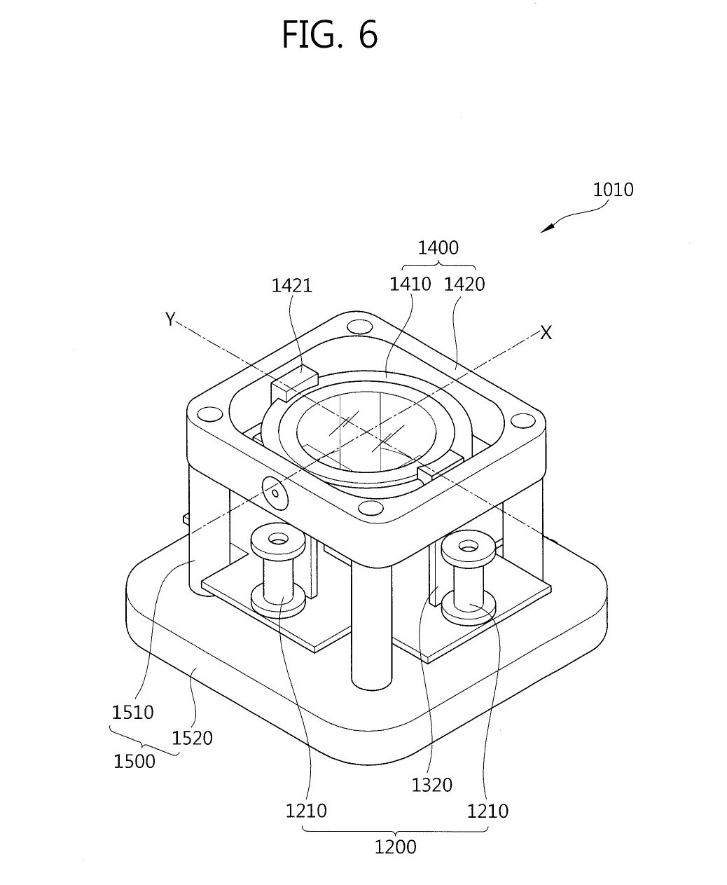

An optical assembly 1010 according to a second embodiment of the present invention is now described with reference to FIGS. 6 to 15. However, the configurations and functions similar to those in the above-described embodiment and similar-type variations are not described.

FIG. 6 is a perspective view illustrating an optical assembly according to a second embodiment of the present invention. The optical assembly 1010 according to this embodiment includes a frame 1500, a supporter 1400 provided in the frame 1500, an optical member 1100 provided to be rotatable by the supporter 1400, and a power providing unit 1200 that supplies power to optical member 1100 to rotate the optical member 1100. The optical apparatus further includes a position sensing unit 1300 for sensing the rotational position of the optical member 1100 that is rotated by the power providing unit 1200 and a controller (not shown) that controls the power providing unit 1200 in accordance with the rotational position of the optical member 1100 that is sensed by the position sensing unit 1300.

Specifically, the frame 1500 forms the shape of the optical assembly 1010 and has various components therein. As illustrated in FIG. 6, the frame 1500 in this embodiment includes a base 1520 and a plurality of pillar members 1510 that are formed on the base 1520. Although not shown in the drawings, a separate connecting part may be provided on the base 1520 to allow the optical apparatus to be installed in the optical apparatus.

The optical member 1100, like in the above-described embodiment, may include a mirror shaped as a plate. The optical member 1100 may be rotatably installed in the supporter 1400. Accordingly, it may be arranged on a path along which light travels to change the path of light that is reflected by a mirror as the optical member 1100 is rotated. However, in this embodiment, the mirror is used as an example of the optical member, but other various optical elements may be used as well.

The optical member 1100 is rotatably installed in the supporter 1400. At this time, the optical member 1100 is configured to be rotatable in the direction of a first axis (X), a second axis (Y), and a combination thereof, while installed in the supporter 1400. Accordingly, the optical member 1100 may be rotated in various directions and may form various paths of light that is reflected by the mirror.

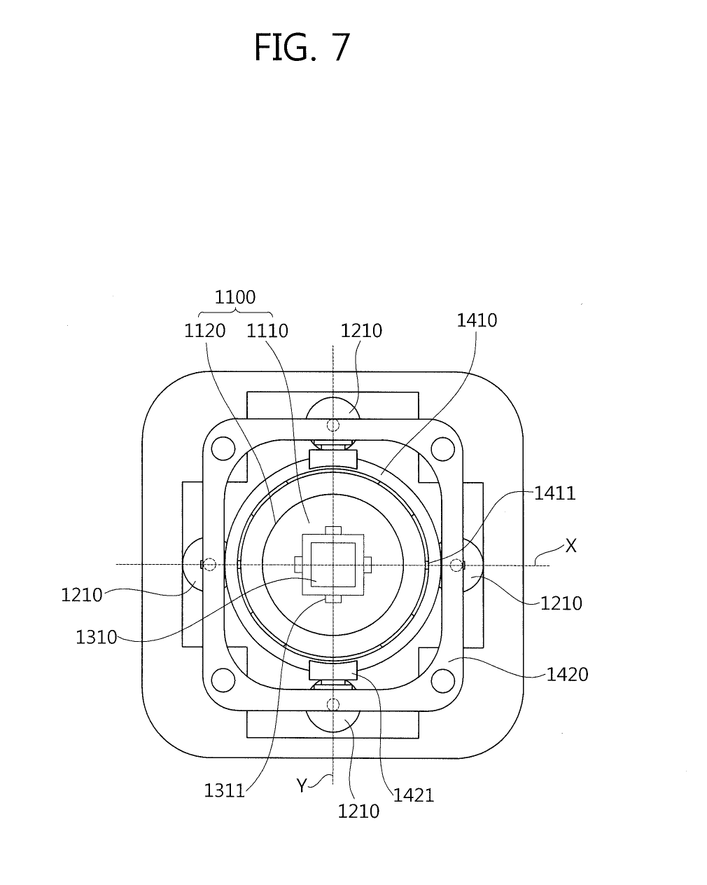

FIG. 7 is a plan view of the optical apparatus shown in FIG. 6. As shown in FIG. 7, the optical member 1100 may be formed of a circular plate. The supporter 1400 includes a first holder 1410 that is arranged at an outer side along the circumference of the optical member 1100 and a second holder 1420 that is arranged at an outer side along the circumference of the first holder 1410.

As shown in FIG. 7, the optical member 1100 is installed in the first holder 1410 of the supporter 1400. In the first holder 1410 is provided a pair of first axis bearings 1411 in the first-axis direction. The optical member may be rotated along the first axis (X) while installed in the first holder 1410 by the first axis bearing 1411.

The second holder 1420 is installed on the frame 1500. In the second holder 1420 is provided a pair of second axis bearings 1421 in the second-axis direction. Accordingly, the first holder 1410 and the optical member 1100 may be rotated along the second axis (Y) while installed in the second holder 1420 by the second axis bearing 1421.

As such, the optical member 1100 may be rotated in the first-axis (X) direction by the first axis bearing 1411 and may be rotated in the second-axis (Y) direction by the second axis bearing 1421. Further, the optical member 1100 may be rotated in the direction of a combination of the first axis and the second axis using the first axis bearing 1411 and the second axis bearing 1421. Here, since the first axis and the second axis form directions perpendicular to each other, the mirror of the optical member 1100 may change the path of light reflected in various two-dimensional ways.

However, in this embodiment, the supporter that supports the optical member using the first holder 1410 and the second holder 1420 is described above as an example. However, the supporter may be configured in various manners.

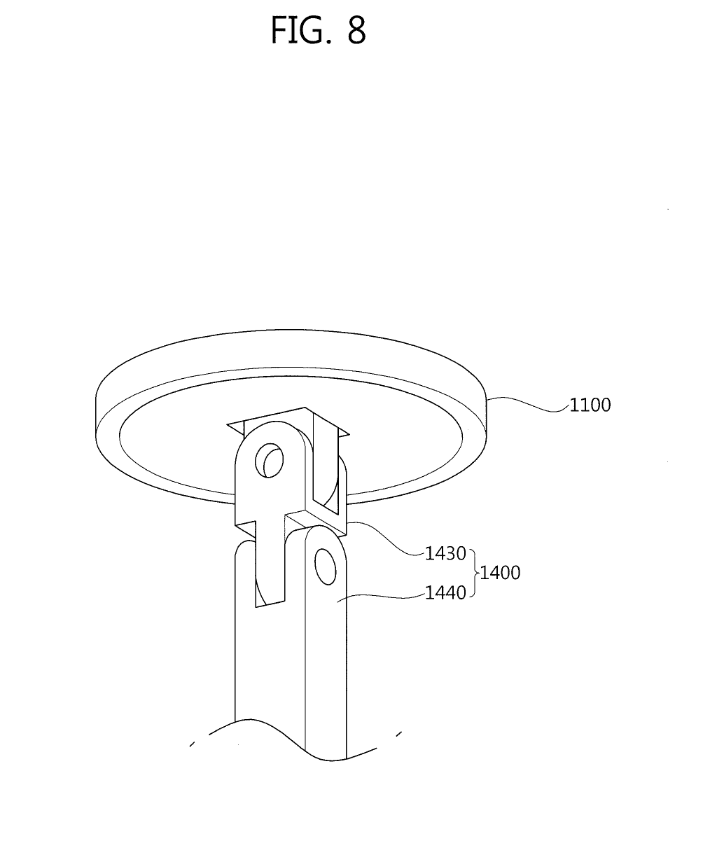

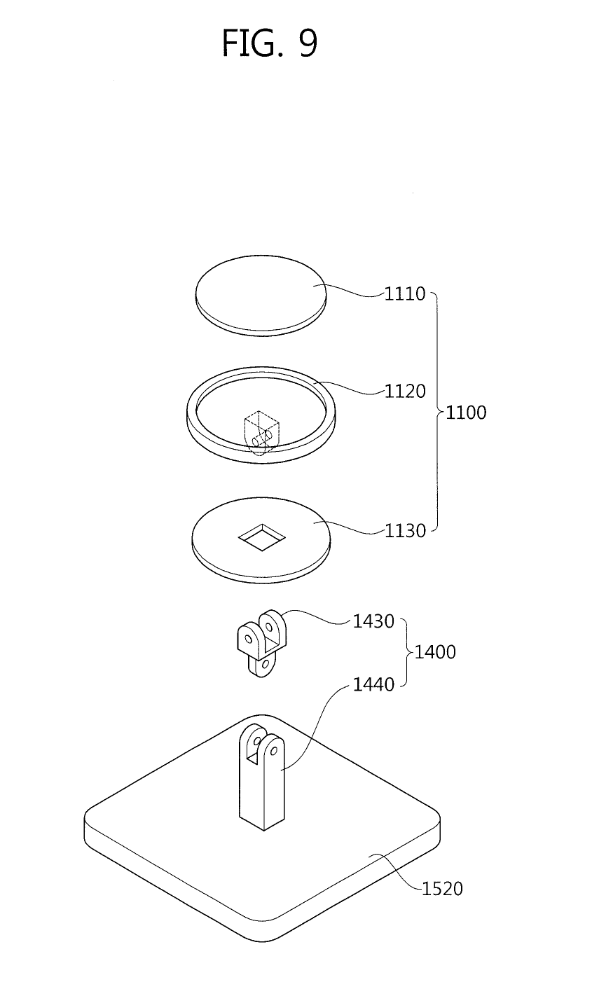

As another example, as shown in FIGS. 8 and 9, a supporter uses a pillar structure having two or more hinge members.

Specifically, the supporter of the optical member includes a first supporting member 1430 in which the optical member is installed and a second supporting member 1440 in which the first supporting member 1430 is installed. The first supporting member 1430 has a hinge shaft that is positioned in the first-axis direction, so that the optical member 1100 may be rotated in the first-axis direction while installed in the first supporting member 1430. The second supporting member 1440 has a hinge shaft that is placed in the second-axis direction, so that the optical member 1100 and the first supporting member 1430 may be rotated in the second-axis direction while installed in the second supporting member. Accordingly, the optical member 1100 may be rotated in the direction of the first axis, the second axis, and a combination thereof using the supporter.

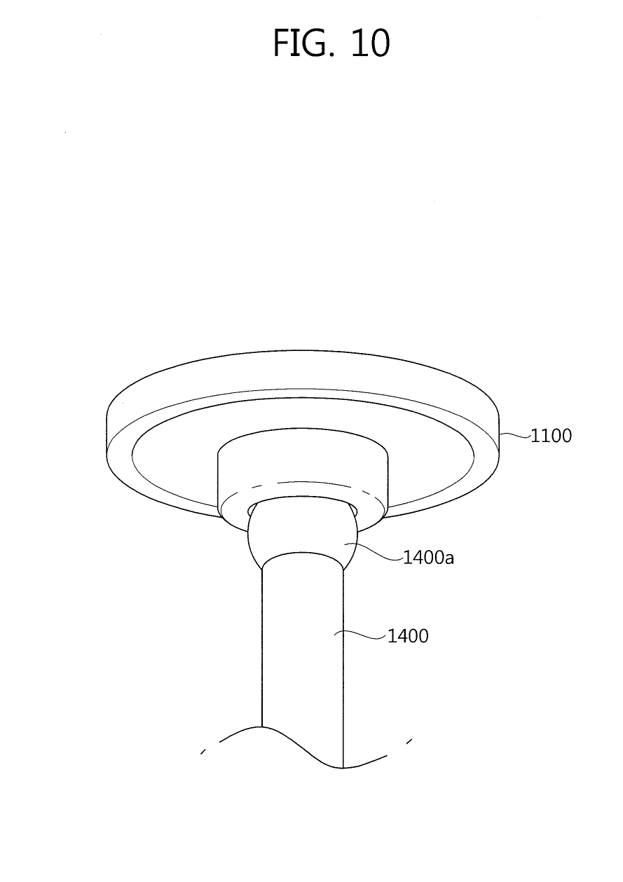

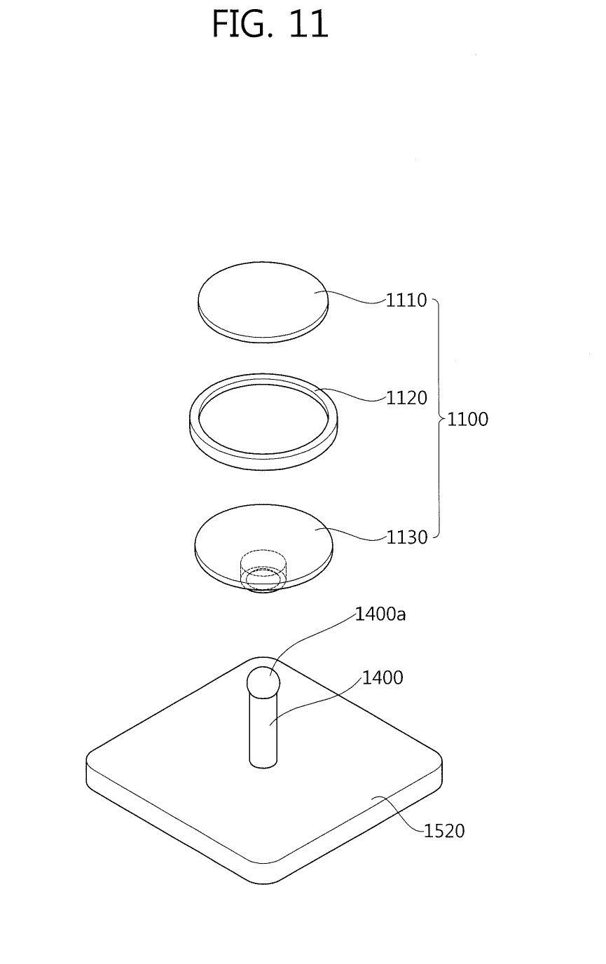

As another example, the supporter 1400 may be configured as shown in FIGS. 10 and 11. In FIGS. 10 and 11, the supporter has a pillar structure with a ball bearing 1400a.

Specifically, the optical member 1100 is installed at an end of the supporter 1400, and the end of the supporter 1400 where the optical member 1100 is installed has a ball bearing 1400a. Accordingly, the optical member 1100 is inserted into the ball bearing 1400a and may thus be freely rotated in all directions.

The supporter according to an embodiment and two more different embodiments have been described thus far. Other various structures may be applicable to the optical member.

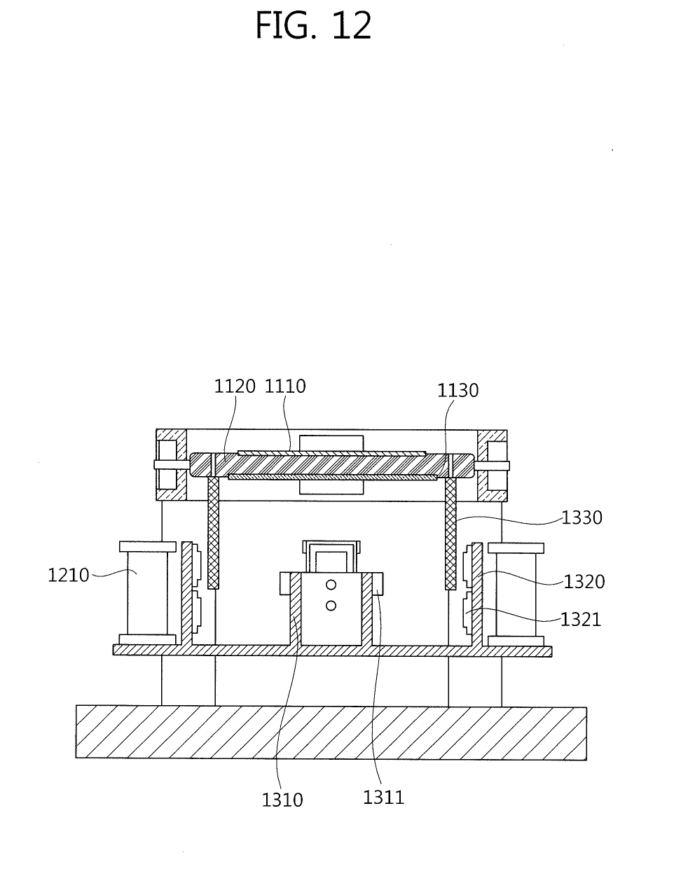

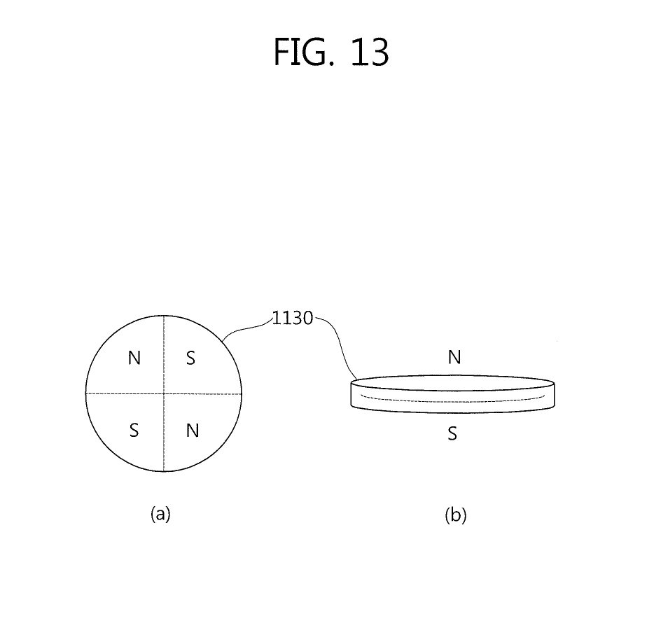

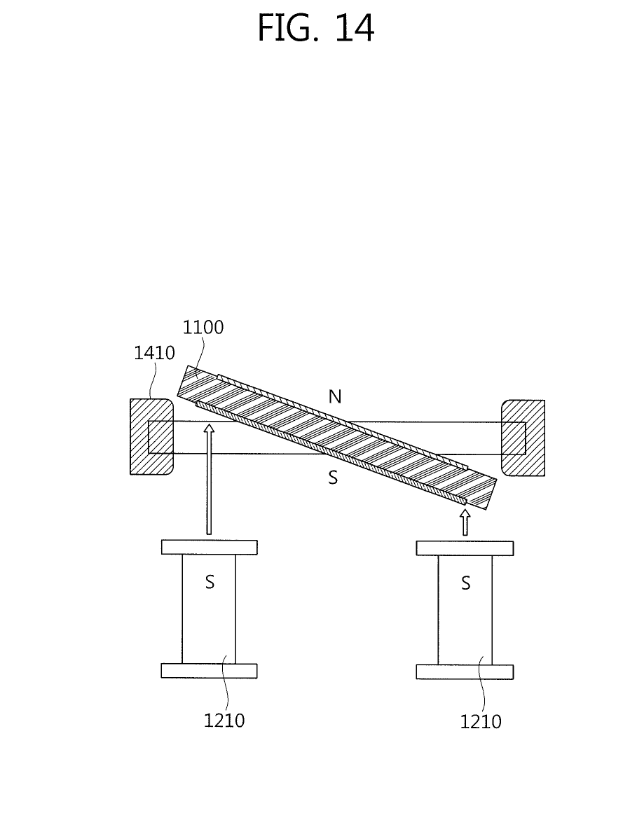

Meanwhile, FIG. 12 is a cross-sectional view of the optical apparatus shown in FIG. 6. As shown in FIG. 6, the power providing unit 1200 is provided at a lower side of the optical member 1100. Here, the power providing unit 1200 includes a plurality of magnetic force units 1210 that generates a magnetic force and supplies the magnetic force to the optical member 1100 for rotation of the optical member 1100. An optical member and a driving method by a power providing unit according to the present invention are hereinafter described in greater detail with reference to FIGS. 13 and 14.

As shown in FIG. 12, an optical member 1100 includes a mirror 1110, a mirror plate 1120, and a magnetic body 1130. The mirror 1110 is exposed from an upper surface of the mirror plate 1120 to be able to change the direction in which light travels on a light path.

The mirror plate 1120 is configured in a plate structure where the mirror 1110 may be seated and installed. At a lower side of the mirror plate 1120 is formed the magnetic body 1130. In FIG. 13, a separate magnetic body 1130 is placed in the mirror plate 1120. However, the mirror plate itself may be formed of the magnetic body 1130. Thus, the optical member 1100 may be rotated using a magnetic force that is supplied from the magnetic force unit 1210 of the power providing unit 1200.

At this time, the magnetic body 1130 of the mirror plate 1120 may be, e.g., a permanent magnet. Such a permanent magnet, as shown in FIG. 13(a), may have different polarities depending on the position of a lower surface. Or, as shown in FIG. 13(b), the permanent magnet may have different polarities at its upper and lower sides, respectively.

Therefore, the power providing unit 1200 has a plurality of magnetic force units 1210 at a lower side of the optical member 1100, and the magnetic force units 1210 may provide a magnetic force corresponding to a magnetic-pole pattern of the magnetic body to rotate the optical member 1100.

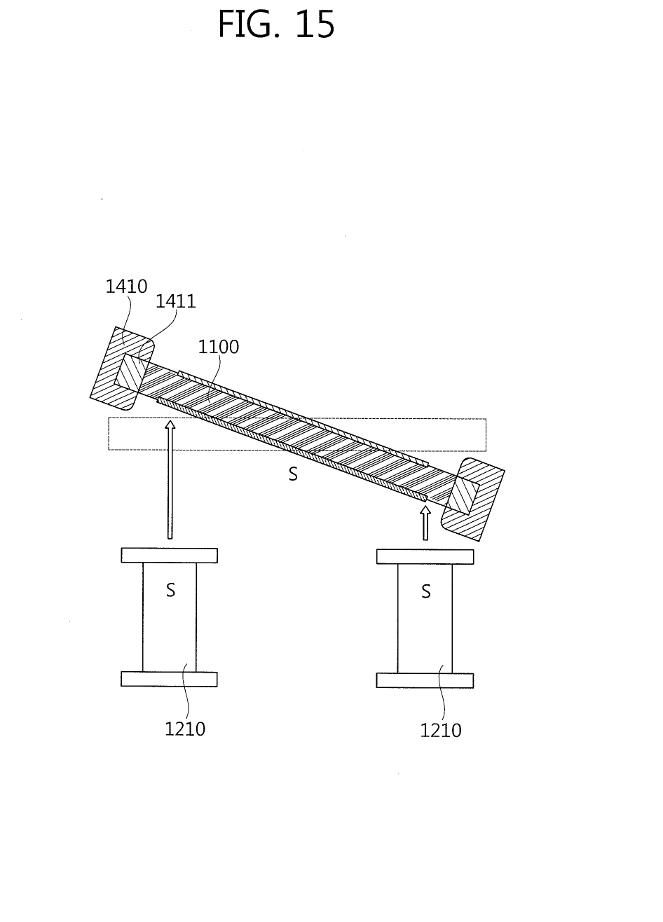

In FIGS. 14 and 15, the power providing unit rotates the optical member along the first and second axes. As shown in FIGS. 14 and 15, the whole lower surface of the optical member 1100 forms S magnetic pole. Here, each magnetic force unit 1210 forms an S magnetic pole, so that a repulsive force is provided to the optical member 1100 as a rotational force.

FIG. 14 illustrates an example where the optical member 1100 is rotated about the first axis. The magnetic force units 1210 that provide a force to allow the optical member 1100 to be rotated about the first axis are symmetrical to each other with respect to the first axis. The two magnetic force units 1210 generate repulsive forces with different strengths. In FIG. 14a, the left-hand magnetic force unit forms a larger magnetic force than that formed by the right-hand magnetic force unit, so that the optical member 1100 maintains equilibrium in magnetic force after rotating a predetermined angle about the first axis.

FIG. 15 shows the optical member 1100 that rotates with respect to the second axis. The magnetic force units 1210 that supply power to rotate the optical member 1100 about the second axis are symmetrical to each other with respect to the second axis. The two magnetic force units likewise generate repulsive forces with different strengths. In FIG. 14b, the left-hand magnetic force unit forms a larger magnetic force than that formed by the right-hand magnetic force unit, so that the optical member 1100 and the first holder 1410 rotate a predetermined angle about the second axis and then maintain equilibrium in magnetic force.

As such, the magnetic force units 1210 of the power providing unit 1200 may be configured so that the magnetic force generated from each of the magnetic force units 1210 may be independently controlled by the controller. Accordingly, the strength of each magnetic force unit may be individually controlled so that the optical member 1100 may be rotated in the direction of the first axis, the second axis, and a combination thereof.

In this embodiment, four magnetic force units 1210 are used and the magnetic force units 1210 are spaced apart from each other at the interval of 90 degrees along the circumferential direction of the optical member 1100. Each magnetic force unit 1210 may be arranged to be adjacent to an edge of the optical member 1100 considering moment.

Here, two magnetic force units that provide power to rotate the optical member 1100 along the first axis (X) may be positioned on the second axis (Y) and may be symmetrical to each other with respect to the first axis. Two magnetic force units that provide power to rotate the optical member 1100 along the second axis (Y) may be positioned on the first axis (X) and may be symmetrical to each other with respect to the second axis (refer to FIG. 6).

However, the present invention is not limited as having the arrangement of the magnetic force units according to this embodiment, and various arrangement patterns may be adopted. In this embodiment, the repulsive forces between two magnetic force units are used to rotate the optical member. However, two or more magnetic force units may be combined to rotate the optical member, and attractive forces, as well as repulsive forces, may also be used to maintain magnetic force equilibrium.

Meanwhile, as the optical member is rotated by the power providing unit, the position sensing unit 1300 senses the rotational position of the optical member 1100. At this time, the position sensing unit 1300 may include a light source 1311, a light sensor 1321, and a light shielding unit 1330 that are installed in the optical assembly 1010.

As shown in FIG. 12, the light source supporter 1310 is formed at a lower side of the optical member 1100. The light source 1311 is installed in the light source supporter 1310 and illuminates light from an inner side to an outer side.

A plurality of light sensor supporters 1320 is formed at the outer side of the light source supporter 1310. The plurality of light sensors 1321 are installed in the light sensor supporters 1320. At this time, the light sensor 1321 is installed to face the light source 1311 at a position corresponding to the light source and receives light from the light source 1311.

Meanwhile, a light shielding unit 1330 is positioned between the light source 1311 and the light sensor 1321 to selectively shield the light sensor 1321. Here, although “the light shielding unit selectively shields the light sensor,” from other points of view, it may also be interpreted as the light shielding unit selectively shielding the light source or light emitted from the light source.

The light shielding unit 1330 is provided to interwork with the rotation of the optical member 1100. Accordingly, as the optical member 1100 rotates, the light shielding unit 1330 moves, thus varying the amount and position of light that is emitted from the light source 1311 and received by the light sensor 1321. Thus, the position sensing unit 1300 may sense the rotational position of the optical member 1100 by detecting the amount and position of light sensed by the light sensor 1321.

Specifically, the light shielding unit 1330 includes at least one extension that is extends to a lower side of the optical member 1100. In this embodiment, the optical member includes four extensions that are arranged to be spaced apart from each other at the interval of 90 degrees. Each extension may be positioned at a lower side of the first axis bearing 1411 and the second axis bearing 1421. Therefore, the light shielding unit 1330 moves as the optical member 1100 rotates, selectively shielding the light sensor 1321.

In this embodiment, four light sensor supporters 1320 are provided and are spaced apart from each other at the interval of 90 degrees along the circumference of a lower side of the optical member 1100. At this time, each light sensor supporter 1320 may be positioned at a lower side of the first axis bearing 1411 and the second axis bearing 1421.

The light sensor 1321 is installed in the direction of the light source 1311 in each light sensor supporter 1320. At this time, the light sensor 1321 is preferably configured so that a part of light emitted from the light source is shielded and another part of the light is received while the light shielding unit 1330 moves as the optical member 1100 rotates. If in a specific section the light shielding unit fully shields or does not shield the light sensor, even when the optical member rotates in the corresponding section, there is no change in the amount or position of light received by the light sensor, thus making it difficult to catch the precise rotational position of the optical member.

Accordingly, in this embodiment, a plurality of light sensors 1321 are provided in one light sensor supporter 1320 along the longitudinal direction, so that a part of light remains shielded in the trajectory along which the light shielding unit 1330 travels while another part of the light may be continuously received.

As such, the position sensing unit 1300 according to this embodiment may precisely sense the rotational position of the optical member 1100 by combining the amount and position of light received by the plurality of light sensors 1321 provided in the plurality of light sensor supporters 1320 as the rotational position of the optical member 1100 varies, through the light sensors 1321.

A controller (not shown) may receive, in real time, the rotational position information of the optical member 1100 that is sensed by the position sensing unit 1300 and may control the power providing unit 1200, thus allowing for accurate position control on the optical member 1100. Accordingly, such an optical apparatus may be used in various laser equipment such as medical or surgery devices using laser, which requires the position of light illumination to be accurately controlled.

Although in this embodiment the specific configurations and positions of the light sensor, light source, and light shielding unit are adopted for convenience of description, the present invention is not limited thereto. As mentioned above in connection with the above-described embodiments, the configuration of the position sensing unit according to the present invention may be modified in various manners with the light sensor, light source and light shielding unit changed in design in light of various positions and structures.

1. An optical assembly comprising:
an optical member;
a supporter provided so that the optical member is rotated in a direction of a first axis, a second axis, or a combination of the first axis and the second axis;
a power providing unit supplying power to rotate the optical member; and
a position sensing unit including a plurality of light sensors, wherein the position sensing unit senses a rotational position of the optical member.

2. The optical assembly of claim 1, further comprising a controller controlling a driving of the power providing unit in accordance with the rotational position of the optical member that is sensed by the position sensing unit.

3. The optical assembly of claim 1, further comprising at least one light source positioned at a lower side of the optical member and emitting light, wherein the position sensing unit senses the rotational position of the optical member based on the amount or position of light emitted from the light source.

4. The optical assembly of claim 3, further comprising a light shielding unit formed between the light source and the position sensing unit, wherein the light shielding unit selectively shields the position sensing unit in accordance with the rotational position of the optical member.

5. The optical assembly of claim 4, wherein the light source is provided to emit light from a lower side of the optical member to an outer side of the optical member, wherein the plurality of light sensors is arranged corresponding to a direction in which light is emitted from the light source along an outer direction of the optical member, and wherein the light shielding unit is extended from a lower surface of the optical member to a lower side and rotates with the optical member to selectively shield the position sensing unit.

6. The optical assembly of claim 4, wherein the plurality of light sensors of the position sensing unit are arranged at a plurality of positions along an outer direction of the optical member, and wherein two or more light sensors are arranged one over another along a vertical direction at each of the positions.

7. The optical assembly of claim 4, wherein some of the plurality of light sensors of the position sensing unit, respectively, are arranged on an extension line of the first axis and an extension line of the second axis.

8. The optical assembly of claim 3, wherein the supporter includes a first holder formed along a circumference of the optical member so that the optical member is rotatably provided in the first-axis direction and a second holder formed along a circumference of the first holder so that the optical member and the first holder are rotatably provided in the second-axis direction.

9. The optical assembly of claim 3, wherein the supporter includes a first holder hinge-coupled to a lower side of the optical member so that the optical member is rotatable in the first-axis direction and a second holder hinge-coupled to an end of the first holder so that the optical member and the first holder are rotatable in the second-axis direction.

10. The optical assembly of claim 3, wherein the supporter includes a supporting table that is provided at a lower side of the optical member and supports the optical member and a ball bearing-shaped holder that is provided between the optical member and the supporting table.

11. The optical assembly of claim 3, wherein the whole or part of the optical member is magnetized, wherein the power providing unit includes a plurality of magnetic force units that generate a magnetic force and supplies power to rotate the optical member using the magnetic force.

12. The optical assembly of claim 11, wherein the optical member includes a mirror and a mirror plate where the mirror is installed, and wherein the mirror plate includes a magnetic body having a magnetic pole.

13. The optical assembly of claim 11, wherein the strength of a magnetic force generated from each of the plurality of magnetic force units is independently controlled.

14. The optical assembly of claim 13, wherein the plurality of magnetic force units include four magnetic force units that are arranged at a lower side of the optical member to be spaced apart from each other at the interval of 90 degrees along a circumferential direction of the optical member.

15. The optical assembly of claim 14, wherein two magnetic force units of the four magnetic force units provide power to rotate the optical member along the first axis and are arranged on a line of the second axis with respect to the first axis, and in the other two magnetic force units provide power to rotate the optical member along the second axis and are arranged on a line of the first axis with respect to the second axis.

16. An optical assembly comprising:
an optical member;
a power providing unit providing power to rotate the optical member;
a light shielding unit rotated together with the optical member by the power provided from the power providing unit;
a light source provided at a side of the light shielding unit and emitting light; and
at least one light sensor provided at another side of the light shielding unit and receiving the light emitted from the light source, wherein the light shielding unit selectively shields a part of the at least one light sensor in accordance with a rotational position, and wherein the light sensor senses the rotational position of the optical member based on the amount or position of the light emitted from the light source.

17. The optical assembly of claim 16, wherein one of the light source and the light sensor is provided to be adjacent to an extension line of a rotational axis of the optical member, and the other thereof is provided on a circumference having a predetermined radius from the rotational axis of the optical member.

18. The optical assembly of claim 17, wherein the light shielding unit is rotated with respect to the same rotational axis as the optical member and is extended by a predetermined length in the direction of the rotational axis between the light source and the light sensor to selectively shield the light sensor.

19. The optical assembly of claim 18, further comprising a controller controlling a driving of the power providing unit in accordance with the rotational position of the optical member that is sensed by the light sensor.

20. The optical assembly of claim 17, wherein the optical member is rotatably provided at a side of the power providing unit, and a stage is provided at another side of the power providing unit, the light source and the light sensor installed in the stage, wherein the at least one light source is installed at a central portion of the stage and emits light in a direction of an outer side, and wherein the plurality of light sensors are arranged along an outer edge of the stage.
